(19) United States
(12) Patent Application Publication
(10) Pub. No.: US 2021/0303812 A1
(43) Pub. Date: Sep. 30, 2021

(54) THERMAL PATTERN SENSOR

(71) Applicant: COMMISSARIAT A L'ENERGIE ATOMIQUE ET AUX ENERGIES ALTERNATIVES, Paris (FR)

(72) Inventors: Jean-François MAINGUET, Grenoble Cedex 09 (FR); Sébastien BECKER, Grenoble Cedex 09 (FR); Bruno CHARRAT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/215,619

(22) Filed: Mar. 29, 2021

(30) Foreign Application Priority Data
Mar. 30, 2020 (FR) 20 03140

(51) Int. Cl. G06K 9/00; G01J 5/06

(52) U.S. Cl. CPC G06K 9/0002; G01J 5/34; G01J 5/06

(57) ABSTRACT

A thermal pattern sensor including a matrix of pixels each comprising:
a detection element formed by a portion of a detection material having a temperature coefficient of resistance greater than 0.2%/K;
a metal portion configured to heat the detection element;
a dielectric portion electrically insulating part of the detection element from the metal portion;
and wherein:
the detection elements of a same column of pixels all have the same electrical resistance value and are electrically coupled to each other and to a readout circuit;
the metal portions of the same row of pixels are electrically coupled to each other;
the sensor further includes an electromagnetic shielding layer covering all the detection elements and electrically insulated from said detection elements.

### TECHNICAL FIELD

The invention relates to a thermal pattern sensor, advantageously used to perform fingerprint capture by thermal detection.

### STATE OF PRIOR ART

It is known to make a fingerprint sensor including thermal detection means. These thermal detection means can correspond to pyroelectric capacitors, diodes, thermistors or, more generally, any thermosensitive element that converts a variation in temperature experienced by the thermosensitive element into a variation in an electrical parameter of the thermosensitive element, such as an electric potential across the thermosensitive element, an electric current generated by the thermosensitive element or a variation in the electrical resistance of the thermosensitive element.

Fingerprint detection can be carried out by so-called “passive” sensors which utilise a temperature difference between the finger and the sensor, as described in documents U.S. Pat. Nos. 4,394,773, 4,429,413 and 6,289,114. However, the drawback of these sensors is that they perform a measurement which only depends on this temperature difference. This can result in the signal level obtained at the output being zero when the finger and the sensor are at the same temperature, or in the contrast of the captured images varying, which then causes problems upon subsequently digitally processing the captured images.

In order to overcome these problems encountered with passive thermal sensors, and also to be able to carry out static acquisition of the fingerprint where the finger does not move, so-called “active” sensors have been provided, such as that described in documents U.S. Pat. No. 6,091,837 and EP 2 385 486 A1.

In such an active sensor, each pixel can include a pyroelectric capacitor formed by two conductive electrodes between which a portion of pyroelectric material is disposed, and a heating element. This heating element dissipates a quantity of heat in the pixel (especially in the portion of pyroelectric material), and heating of the pixel is measured after an acquisition time in the presence of the finger on the sensor.

At each pixel, it is possible to distinguish between the presence of a ridge or a valley of the captured fingerprint, depending on whether part of the heat supplied by the heating element is absorbed by the skin (pixel in the presence of a ridge of the fingerprint) or retained in the pixel (pixel in the presence of a valley in the fingerprint). At the end of the acquisition time, the temperature of a pixel in the presence of a ridge, where heat is absorbed by the skin, is lower than that of a pixel in the presence of a valley, where heat is not absorbed by the skin and remains in the pixel.

In the first order, such a sensor enables the measurement of the heat capacity, also called specific heat or specific thermal capacity, of an element (the finger when a fingerprint is captured) in contact with the pixels of the sensor. Measurements obtained also depend on the conductivity and thermal capacity of various materials involved between the pixels of the sensor and the part of the element (ridge or valley in the case of a fingerprint) being present on each pixel.

When a thermal pattern is captured by an active thermal detection sensor, all the pixels of the sensor are read in the same way, and regularly at the same rate, that is, with the same fixed measurement period of time for all the pixels. This measurement period of time, which corresponds to a period of time during which a pixel performs thermal measurement of the element being in contact therewith, is generally adjusted so as to obtain a good contrast between ridges and valleys of the fingerprint, that is, is sufficiently long for the heat to have had time to propagate in order to obtain a significant signal to noise ratio. However, this measurement period of time should not be too long so that the total capture period of time remains acceptable to the user and the measurement is not disturbed by finger movements on the sensor surface.

Pixel reading performed in an active thermal detection sensor can correspond for example to a measurement of charges generated in each pixel, which is implemented with a charge integrator, but other methods are possible depending on the thermal detection means used.

Document WO 2018/020176 A1 describes a thermal pattern sensor in which pixel addressing is carried out by rows of conductive material each heating pixels in a row of the sensor matrix, without the need for transistors within the pixels. When the heating current is switched off during pixel reading, this causes a detrimental capacitive pulse on the columns of pixels formed by pyroelectric capacitors. The presence of a shielding layer in such a sensor avoids the recovery of the electric field present around the sensor, in particular that related to the above described capacitive pulse, and also protects it from other outer electromagnetic disturbances such as electrostatic discharges.

Document FR 3 069 938 A1 describes another type of thermal sensor in which the matrix of pixels is formed by resistive elements corresponding to amorphous silicon capsules having an electrical resistance value which varies as a function of temperature. Heating rows are superimposed with columns of resistive elements to vary the electrical resistance values of the resistive elements of a row of pixels to be read. The pixels can be read in voltage by injecting a constant current into the columns of pixels. However, when the sensor has a large number of rows, it is suitable to use current sources injecting currents with very low values (less than 50 nA) in order to avoid excessive voltages input to the readout circuits. Such current sources are complex to make.

Alternatively, the pixels can be read in current by biasing each column of resistive elements with a bias voltage, which enables a read current to be recovered at the bottom of each column, which is then integrated by a capacitive transimpedance amplifier (CTIA). It is also possible to use compensating resistors and calibration pixels in order to read only the useful current to discriminate the presence of skin or air on the pixels read.

In some cases, the use of PVDF for making a thermal pattern sensor is a drawback because of its low hardness, making the sensor sensitive to punching, as well as because of its Curie temperature in the order of 110 to 130 degrees C., which, if exceeded, makes the sensor inoperative. In addition, the fact that an initial bias of the PVDF has to be carried out with a very high electric voltage, in the order of 300 V or 400 V, is a constraint for industrially making these sensors.

### DISCLOSURE OF THE INVENTION

Thus there is a need to provide a thermal pattern sensor performing thermal detection of the pattern and not including a PVDF-based pyroelectric capacitor.

For this, one embodiment provides a sensor of a thermal pattern of an element intended to be in contact with the sensor, measuring thermos-resistive properties of a detection material, including a matrix of a plurality of rows and columns of pixels, each pixel comprising at least:
a detection element formed by a portion of the detection material which is print-depositable and has a temperature coefficient of resistance greater than about 0.2%/K;
a metal portion configured to heat the detection element of the pixel;
a first portion of dielectric material disposed between the detection element and the metal portion, configured to provide electrical insulation of at least part of the detection element from the metal portion;

and wherein:
the detection elements of a same column of pixels all have substantially a same electrical resistance value and are electrically coupled to each other and to a readout circuit configured to read an electric current for passing through said detection elements;
the metal portions of a same row of pixels are electrically coupled to each other;
the sensor further includes an electromagnetic shielding layer covering all the detection elements of the matrix and electrically insulated from said detection elements.

This sensor provides a thermal detection pixels matrix that does not include pyroelectric capacitors, and therefore does not have the drawbacks related to the use of PVDF or PVDF-like materials.

The sensor performs thermal detection and does not correspond to a capacitive type sensor or a sensor detecting pressure differences because in the sensor, it is a variation in electrical resistance that is read and not a capacitance value.

Further, the sensor resorts to a print-depositable material for making the detection elements, which enables the sensor to be made using low-cost print deposition techniques.

The element comprising the thermal pattern to be detected by the sensor is to be in physical contact with the sensor, that is, disposed against the sensor when the thermal pattern is detected.

The thermal pattern detected by the sensor advantageously corresponds to a fingerprint, but may correspond to any pattern having a thermal capacity and a specific heat.

A print-depositable material corresponds to a material that is initially in liquid or paste form when deposited, and which then solidifies either naturally or by implementing at least one solidification step (for example, drying, polymerisation, etc.).

Print deposition corresponds, for example, to one of the following techniques: screen printing, gravure printing or rotogravure, letterpress, offset, slot die coating.

The feature of these printing techniques is that they do not require the implementation of additional etching steps after deposition: the material is directly deposited in the desired pattern. For example, it is not necessary to deposit another light-sensitive material (for example, a photosensitive resin), to expose this photosensitive material through a mask to delimit zones, to remove the parts exposed (or not exposed if it is a negative resin) using a specific solvent or another technique, and then to apply an etching technique adapted to the desired material. This avoids the need for relatively expensive photolithography-type technologies.

Advantageously, the detection material may be PEDOT:PSS, and/or the electromagnetic shielding layer may comprise PEDOT:PSS.

In this case, the PEDOT:PSS of the detection elements and/or the electromagnetic shielding layer may include a PSS to PEDOT weight ratio between about 2.5 and 10.

More generally, the detection element is formed by a portion of material comprising PEDOT:PSS and/or graphene and/or use Cytochrome c type proteins, and having a temperature coefficient of resistance greater than about 0.2%/K.

The electromagnetic shielding layer may include a material identical to that of the detection elements. Such an alternative is highly advantageous as it simplifies making the sensor.

The sensor may further include a circuit configured to apply, to the metal portions, a heating voltage dissipating in each pixel a power between about 0.1 mW and 1 mW, or between 0.01 mW and 10 mW. The heating power dissipated in each pixel especially depends on the sensitivity of the detection element material, the readout circuit, and the thickness of the protective layer covering the pixel.

The detection elements may have an electrical conductivity between 0.3 and 20,000 S·m⁻¹, depending on their composition. In a configuration where the detection elements are placed in series, it is possible to favour higher conductivities as the total resistance tends to increase with an increasing number of pixels, whereas in a configuration where the detection elements are placed in parallel, it is possible to favour the opposite with lower conductivities.

The sensor may comprise a plurality of readout circuits each electrically coupled to at least one of the columns of pixels, and each readout circuit may include at least:
a capacitive transimpedance amplifier an input of which is electrically coupled to the detection elements of said at least one of the columns of pixels, and
a feedback capacitor comprising a first electrode electrically coupled to said input of the capacitive transimpedance amplifier and a second electrode electrically coupled to an output of the capacitive transimpedance amplifier, and
a switch electrically coupled in parallel to the feedback capacitor.

The sensor may further include a plurality of electric compensating resistors each electrically coupled to the detection elements of a column of pixels and having a value equal to the sum of the electrical resistances of the detection elements of said column of pixels. Such electric compensating resistors enable a more accurate measurement of the thermal pattern by removing all or part of the fixed part of the signal when the sensor is at rest.

Electric compensating resistors may include at least one portion of the detection material having a similar composition (that is, formed by the same elements or chemical compounds, and in the same concentrations) to that of the pixel detection elements.

The sensor may further include a plurality of electric calibration resistors each electrically coupled to the detection elements of a column of pixels.

The electric calibration resistors may be formed by at least one portion of the detection material having a similar composition to that of the detection elements of the pixels, thermally coupled to a metal row that includes a first end connected to the ground and a second end electrically coupled to the metal portions of the pixels.

According to different embodiments, the sensor may be such that:
the detection elements of each pixel are formed by portions of the detection material that are distinct from each other, or
the detection elements of the pixels belonging to a same column are formed by a single portion of the detection material, or
the detection elements of the pixels belonging to a plurality of juxtaposed columns are formed by a single portion of the detection material, or
the detection elements of all the pixels of the sensor are formed by a single portion of the detection material.

The detection elements of a same column of pixels may be electrically coupled in parallel to each other by a first metal row electrically coupled to first ends of the detection elements of said column of pixels and to which a bias voltage is to be applied, and by a second metal row electrically coupled to second ends of the detection elements of said column of pixels and through which the detection elements of said column of pixels are electrically coupled to the readout circuit.

At least one first metal row may be common to two juxtaposed columns of pixels and/or at least one second metal row may be common to two juxtaposed columns of pixels.

The sensor may further include an electric bias metal row electrically coupled to the detection elements of the pixels, and in each pixel, the first portion of dielectric material electrically insulates the entire detection element from the metal portion.

The sensor may further include a protective dielectric layer covering each of the pixels.

### BRIEF DESCRIPTION OF THE DRAWINGS

The present invention will be better understood upon reading the description of exemplary embodiments given purely by way of indicating and in no way limiting purposes, with reference to the appended drawings in which:

FIG. 1 schematically shows part of a thermal pattern sensor according to a first embodiment;

FIG. 2 schematically shows an example of a stack of materials of the thermal pattern sensor;

FIG. 3 schematically shows an exemplary embodiment of one of the readout circuits coupled to a column of pixels of a thermal pattern sensor;

FIG. 4 schematically shows part of a thermal pattern sensor according to a second embodiment;

FIG. 5 shows the equivalent electrical diagram of a column of pixels of the thermal pattern sensor according to the second embodiment, coupled to one of the readout circuits of the sensor;

FIG. 6 schematically shows part of a thermal pattern sensor according to a third embodiment;

FIG. 7 shows the equivalent electrical diagram of a column of pixels of the thermal pattern sensor according to the third embodiment, coupled to one of the readout circuits of the sensor;

FIGS. 8 to 10 each schematically show part of a thermal pattern sensor according to a fourth, fifth and sixth embodiment, respectively;

FIG. 11 schematically shows part of a thermal pattern sensor according to a seventh embodiment and a cross-section view of a pixel of the sensor.

Identical, similar or equivalent parts of the different figures described hereinafter bear the same reference numerals so as to facilitate switching from one fig. to the other.

Different parts shown in the figures are not necessarily to a uniform scale, in order to make the figures more legible.

The different possibilities (alternatives and embodiments) should be understood as being not exclusive of each other and can be combined with each other.

### DETAILED DISCLOSURE OF PARTICULAR EMBODIMENTS

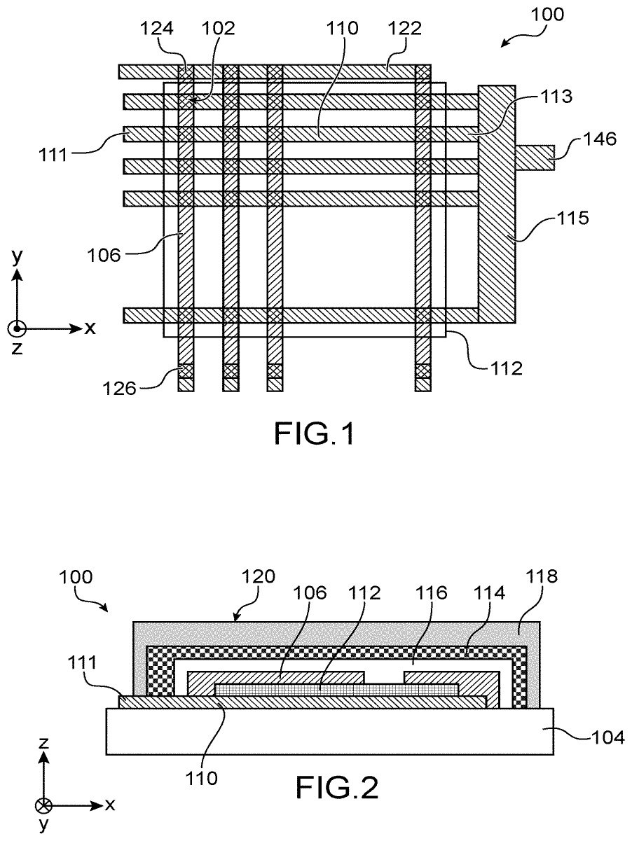

A thermal pattern sensor 100 according to a first embodiment is described below in connection with FIG. 1, which schematically shows a top view of part of the sensor 100, as well as in connection with FIG. 2, which shows a schematic cross-section view of an exemplary stack of materials of the sensor 100.

The sensor 100 includes a matrix of a plurality of rows and columns of pixels 102. The pitch of the pixels 102, that is, the distance between the centres of two neighbouring pixels 102, is for example between about 25 μm and 100 μm, and for example equal to about 50 μm.

According to one exemplary embodiment, the sensor 100 may include 92 rows and 92 columns of pixels 102, and a pitch of pixels 102 equal to about 80 μm or 90 μm. According to another exemplary embodiment, the sensor 100 may include 128 rows of pixels and 128 columns of pixels 102, and a pitch of pixels 102 equal to about 50 μm. Alternatively, the sensor 100 may include an entirely different number of rows and/or columns of pixels 102, and a pitch of pixels 102 with a value different from those indicated above.

The pixels 102 are made on a preferably insulating or dielectric substrate 104 including, for example, glass, or a semiconductor such as silicon including an insulating or partially insulating layer covering the semiconductor. Advantageously, the substrate 104 may be a flexible substrate, for example comprising polyimide or PEN (polyethylene naphthalate) or PET (polyethylene terephthalate).

Each pixel 102 includes a detection element formed by a portion of print-depositable material 106 having a temperature coefficient of resistance (TCR) greater than about 0.2%/K. The detection elements 106 of a same column of pixels 102 all have substantially the same electrical resistance value (a value which may differ slightly from one detection element 106 to another, for example by at most 1%), for example between about 200 kΩ and 4 MΩ, and are electrically coupled to each other and to a readout circuit 108 (not visible in FIGS. 1 and 2) configured to read an electric current for passing through the detection elements 106 of the column of pixels 102.

In the first embodiment described herein, the detection elements 106 of the pixels 102 of each column are formed by a single continuous (that is, uninterrupted between the pixels 102 of the column) portion of said material extending parallel to the Y axis visible in FIG. 1. The detection elements 106 of the pixels 102 of each column are formed by parts of this portion of material facing metal portions 110 configured to heat the detection elements 106. For example, when the pitch of the pixels 102 is equal to 90 μm, each of the parts forming the detection elements 106 of a column of pixels 102 has, for example, lateral dimensions (dimensions along the X and Y axes visible in FIG. 1) equal to 90 μm×45 μm, each of these parts being spaced from those forming the detection elements 106 of a neighbouring column by a distance equal to about 45 μm.

Advantageously, the material forming the detection elements 106 is PEDOT:PSS (a blend of two polymers: poly(3,4-ethylenedioxythiophene) and polystyrene sulfonate), with for example a PSS to PEDOT weight ratio between about 2.5 and 10. This ratio is for example adjusted such that the TCR of the material is between about 2%/K and 3%/K, or slightly lower, for example, 1%/K, in order to obtain a resistivity more adapted to the permissible bias voltages, for example, 3 volts, for a current adapted to the detection circuit, for example, 10 nA, which will result in a total resistance of 300 MΩ, that is, 1.6 MΩ/square.

The thickness of the material deposited to form the detection elements 106 (dimension along the Z axis of the detection elements 106) preferably has a thickness between about 100 nm and 1 μm.

In FIG. 2, two disjoint portions of the material forming the detection elements 106 are shown, for the purpose of illustrating that the detection elements 106 of two columns of pixels 102 are disjoint.

Each pixel 102 also includes a metal portion 110 configured herein to heat the detection element 106 of the pixel 102 by Joule effect.

From an electrical point of view, in this first embodiment, the detection elements 106 of each column of pixels 102 correspond to electric resistors connected in series.

In the sensor 100, addressing of pixels 102 is performed per row, and this addressing function is fulfilled by the metal portions 110. Upon reading a row of pixels 102 of the sensor 100, a current which performs heating by Joule effect passes through the metal portions 110 of the row. Part of the heat produced is transmitted to the detection elements 106 of the pixels 102 of this row, and heat is also transmitted to the upper layers where part of it will possibly be absorbed if skin is in contact with the pixel. The metal portions 110 of a same row of pixels 102 are electrically coupled to each other. In the exemplary embodiment shown in FIG. 1, for each row of pixels 102, the metal portions 110 of the pixels 102 are formed by a same element of metal material extending over the whole width of the matrix of pixels 102, parallel to the X axis visible in FIG. 1.

According to an exemplary embodiment, the metal portions 110 may include titanium and/or molybdenum and/or aluminium and/or gold and/or silver. The metal portions 110 may also be formed by a stack of a plurality of electrically conductive materials, for example a Ti/TiN/AlCu stack. The thickness of the metal portions 110 is for example between about 0.1 μm and 1 μm.

Although not visible in FIGS. 1 and 2, the sensor 100 also includes a circuit configured to apply, to each of the metal portions 110, a heating voltage for addressing the row of pixels 102 associated with that metal portion 110. Heating voltages applied to the metal portions 110 are, for example, such that, in each pixel 102 addressed by one of the metal portions 110, the power dissipated in each pixel 102 is between about 0.1 mW and 1 mW, and for example equal to 0.15 mW. This circuit is coupled to first ends 111 of the metal portions so that it can apply, upon reading a row of pixels 102, an electric potential to the first end 111 of the metal portion 110 of the row of pixels 102 read, different from that to the second end 113. Second ends 113 of the metal portions 110, opposite to the first ends 111, are electrically coupled to each other by a portion 115 of electrically conductive material to which a reference electric potential, for example the ground (referenced 146 in FIG. 1), is applied.

In each pixel 102, the metal portion 110 is electrically insulated from the detection element 106 by a first portion 112 of dielectric material. In the exemplary embodiment shown in FIG. 1, the first portions 112 of dielectric material of all the pixels 102 of the matrix are formed by a first continuous layer (that is, uninterrupted between pixels 102) of dielectric material and common to all the pixels 102 of the matrix. This first dielectric layer also provides electrical insulation between the metal portions 110 of adjacent rows of pixels 102. This first dielectric layer has, for example, a thickness between about 100 nm and 1 μm.

The sensor 100 further includes an electromagnetic shielding layer 114 covering all the pixels 102 and which is electrically insulated from the detection elements 106 of the pixels 102 by a second continuous dielectric material layer 116 common to all the pixels 102 of the matrix. This second layer 116 also provides electrical insulation between the detection elements 106 of adjacent columns of pixels 102. This electromagnetic shielding layer 114 limits disturbances experienced by the sensor 100, especially those with a frequency equal to 50 Hz. This electromagnetic shielding layer 114 has, for example, a thickness between about 100 nm and 1 μm.

Advantageously, the electromagnetic shielding layer 114 includes PEDOT:PSS. It is possible that the PEDOT:PSS of the electromagnetic shielding layer 114 has a PSS to PEDOT weight ratio similar to that of PEDOT:PSS of the detection elements 106.

The sensor 100 also includes a protective dielectric layer 118, preferably having good properties against abrasion, covering all the pixels 102. In FIG. 2, the protective dielectric layer 118 covers the electromagnetic shielding layer 114. This protective dielectric layer 118 includes, for example, one of the following materials: the OC-3021 or OC-4122 coating marketed by the company DYMAX, or the SiIFORT PHC XH100 or UVHC 7300 coating marketed by the company Momentive. The thickness of the protective dielectric layer 118 may be between about 100 nm and 10 μm. When the material of the detection elements 106 is PEDOT:PSS, the protective dielectric layer 108 makes it possible especially to protect this material from moisture likely to be absorbed by this material and which thereby modifies its electrical properties.

An upper face 120 of the protective dielectric layer 118 corresponds to the capture surface of the sensor 100 above which the thermal pattern to be detected is located, for example a finger the fingerprint of which is to be detected and which is in contact with the capture surface of the sensor 100.

The sensor 100 also includes another metal portion 122 to which first ends 124 of the portions of material forming the detection elements 106 are electrically coupled. This metal portion 122 enables an electric bias potential to be applied to the first ends 124 at the tops of the columns of detection elements 106. The portions of material forming the detection elements 106 also have second ends 126, opposite to the first ends 124, connected to the readout circuits 108.

The metal portions 110, 115 and 122 of the sensor 100 are advantageously made in the form of a same metal level, that is, made during common steps at a same time in the process.

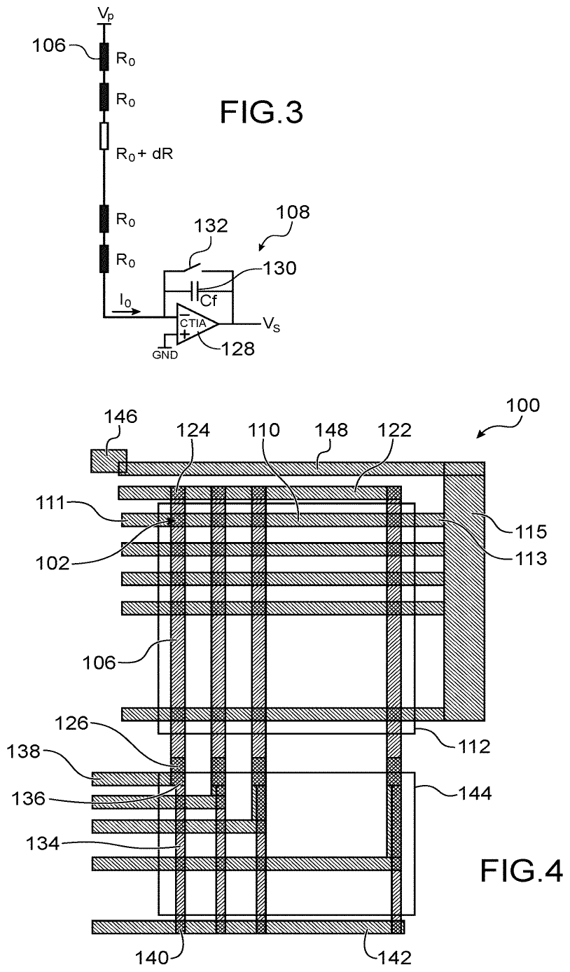

An exemplary embodiment of one of the readout circuits 108 is shown in FIG. 3. The readout circuit 108 is connected to the portion of material forming the detection elements 106 of one of the columns of pixels 102. Each detection element 106 is symbolised as an electric resistor with a value of R₀, and the electric resistors formed by the detection elements 106 of the same column of the matrix of pixels 102 are connected in series. In FIG. 3, the detection element 106 which is heated by the metal portion 110 to which a heating electric potential is applied has an electrical resistance value equal to R₀+dR (which corresponds to a variation in resistance due to heating). In FIG. 3, the bias voltage applied to the first end 124 of the column of the detection element 106 is referred to as V_{P}.

The readout circuit 108 includes a capacitive transimpedance amplifier, or CTIA, 128 comprising a first input (the inverting input in the example of FIG. 3) electrically coupled to the column of detection elements 106, and a second input (the non-inverting input in the example of FIG. 3) connected to an electric reference potential, for example the ground GND. A voltage Vₛ is obtained at the output of the amplifier 128.

The readout circuit 108 also includes a feedback capacitor 130 having a value Cf and electrically coupled in parallel to the amplifier 128, between its output and its first input, and a switch 132 also electrically coupled in parallel to the amplifier 128, between its output and its first input.

Applying the bias voltage V_{P} to the column of detection elements 106 creates a flow of current I₀ through the detection elements 106. In the absence of heating of the detection elements 106 in the column, at a time instant t₀, the current I₀ is:

I₀(t₀)=V_{P}/(n·R₀) (1)

with n corresponding to the number of detection elements 106 present in each of the columns of pixels 102 of the matrix of the sensor 100.

Current is applied from time instant t₀ to the heating elements. After a heating phase of a period of time t, for example 1 ms, of one of the detection elements 106, that is, when a heating current is sent into the element forming the metal portions 110 of one of the rows of pixels 102, the electrical resistance of one of the detection elements 106 of the column of pixels 102 takes the value R₀+dR and the current I₀ becomes:

I₀(t)=V_{P}/(n·R₀+dR) (2)

To initialise the current integrator, the switch 132 is closed a little before the time instant t₀: the charges on the capacitor Cf are cancelled (short-circuit). Then the switch 132 is opened just after time instant t₀ at time instant t₁, for example at least 1 microsecond or 10 microseconds, which is negligible in comparison with the heating time, in order to avoid the electrostatic impulse caused by the voltage change. The current I₀ is then integrated during the heating time in the capacitor Cf and the voltage Vₛ linearly follows the amount of accumulated charges. At a time instant t₂, reading the voltage Vₛ is made, for example 1 ms after t₁.

By approximating the heating process to an exponential response (which is the case in the first order), the variation in the current I₀ from time instant t₁ can be expressed by the following equation:

$${I}_{0} ( t ) = {I}_{0} ( {t}_{0} ) + ( {I}_{0} ( {t}_{2} ) - {I}_{0} ( {t}_{1} ) ) \cdot ( 1 - {e}^{- \frac{t}{τ}} ) \qquad ( 3 )$$

The term I₀(t₂)−I₀(t₁) corresponds to the part of the current generated by the variation dR, and t is the time constant related to the thermal process towards equilibrium.

The amplifier 128 generates the voltage Vₛ which is the image of the integral of the charges accumulated in the capacitor 130, and is expressed as follows:

Vₛ(t)=(1/Cf)∫I₀(t)dt (4)

By considering ΔI₀=I₀(t₂)−I₀(t₁) and integrating this expression, the term Vₛ(t) then becomes:

$${V}_{S} ( t ) = ( \frac{1}{{c}_{f}} ) {I}_{0} ( {t}_{0} ) \cdot t + ( \frac{1}{{c}_{f}} ) Δ {I}_{0} ( t + τ \cdot {e}^{- \frac{t}{τ}} ) \qquad ( 5 )$$

with the value Vₛ(t₂) being calculated between time instants t₁ and t₂.

The first term

$$( \frac{1}{{c}_{f}} ) {I}_{0} ( {t}_{0} ) \cdot t$$

is an offset superimposed with the signal to be measured and corresponds to a constant current, for example with zero heating. This offset will limit the maximum amplitude of the output voltage of the amplifier 128. It can be of a very large value in comparison with that of the second term

$$( \frac{1}{{c}_{f}} ) Δ {I}_{0} ( t + τ \cdot {e}^{- \frac{t}{τ}} )$$

which corresponds to the signal to be measured, if I₀(t₀)>>ΔI₀. The values of the capacitor 130, the quiescent current I₀(t₀) and the integration time t are therefore selected so as not to saturate the amplifier 128. The value Cf of the capacitor 130 has to be small enough to measure the signal. For example, with typical values I₀(t₀)=50 nA and t₂−t₁=2 ms and a maximum output voltage Vₛ(max)=4V, it is possible to have Cf=25 pF. The value of the signal to be measured that is superimposed with a 4V offset voltage of the signal to be measured is, for example, about 1.2 mV (with t=0.6 ms). The desired value corresponds to the discrimination between a pixel in the presence of a ridge of the fingerprint measured and a pixel in the presence of a valley of the fingerprint measured. For example, if the time constant τ for a pixel in the presence of a valley is 0.7 ms and that for a pixel in the presence of a ridge is 0.5 ms, the difference between the values of Vₛ(t₂) for these two types of pixels is 130 μV. It will therefore be wanted to remove or greatly reduce the constant term corresponding to the current I₀(t₀).

A thermal pattern sensor 100 according to a second embodiment is described below in connection with FIG. 4 which schematically shows a top view of part of the sensor 100.

In comparison with the sensor 100 according to the first embodiment, the sensor 100 according to the second embodiment further includes a plurality of electric compensating resistors 134 each electrically coupled to the detection elements 106 of a column of pixels 102 and having a value R_{CMP} equal to the sum of the electrical resistances of the detection elements 106 of the column of pixels 102, that is, such that R_{CMP}=n·R₀.

In the exemplary embodiment shown in FIG. 4, the electric compensating resistors 134 are formed on the substrate 104 by portions of the same material as that forming the detection elements 106. The geometry of these portions of material is identical for all the columns of pixels 102 so that the values of these electric compensating resistors 134 are identical for all the columns of pixels 104.

A first end 136 of each of the electric compensating resistors 134 is electrically coupled to a metal portion 138, advantageously formed of the same material as that forming the metal portions 110. Each of the metal portions 138 is associated with a single electric compensating resistor 134. This metal portion 138 enables the first end 136 of the electric compensating resistor 134 to be electrically coupled to the readout circuit 108 associated with the column of pixels 102.

A second end 140 of each of the electric compensating resistors 134 is electrically coupled to another metal portion 142, advantageously formed by the same material as that forming the metal portions 110. This other metal portion 142 is common to all the electric compensating resistors 134 and is for applying an electric compensating potential V_{CMP} to the second ends 140 of the electric compensating resistors 134.

A layer 144 of dielectric material, advantageously comprising the same material as that forming the first portions 112 of dielectric material, electrically insulates the portions of material forming the electric compensating resistors 134 from the metal portions 138, except at the electrical contact between the first ends 136 and the metal portions 138.

Finally, in FIG. 4, the contact between the portion 115 of electrically conductive material and the ground referenced 146 is made by another metal portion 148 situated outside the matrix of pixels 104.

FIG. 5 shows the electrical diagram of a column of pixels 102 of the sensor 100 according to the second embodiment, that is, with an electric compensating resistor 134 electrically coupled to the detection elements 106 of each column of pixels 102.

By virtue of the electric compensating resistor 134 present at the bottom of each of the columns of detection elements 106, the electric current read by the readout circuit 108 no longer includes the component I₀(t1). Indeed, for each column of pixels 102, the electric compensating resistor 134 is associated with the compensating electric potential V_{CMP}, with negative value, generating an electric compensating current I_{CMP}=V_{CMP}/R_{CMP}. This current I_{CMP} is subtracted from the current I₀ outputted by the detection elements 106 such that the current received at the input of the amplifier 128 is I₀′=I₀−I_{CMP}. Ideally, the current I_{CMP} has a value equal to that of the current passing through the n detection elements 106 such that I_{CMP}=V_{P}/(n·R₀). The potential V_{CMP} is therefore selected such that V_{CMP}=−V_{P}. In the absence of a signal generated by the heating of one of the detection elements 106, there is therefore I₀′(t₀)=I₀′(t₁)=0.

Other values of V_{CMP} and R_{CMP} are possible, as long as the value of the compensating current I_{CMP} is as close as possible to that of the ratio V_{P}/(n·R₀).

The value of V_{CMP} may be adjustable and common to all the columns of pixels 102 of the matrix of the sensor 100. Alternatively, the value of V_{CMP} may be independent for each column of pixels 102 to enable an individual adjustment compensating for any dispersion in the value n. R₀ between the columns of pixels 102. In this case, the sensor 100 includes a plurality of metal portions 142 each coupled to one of the electric compensating resistors 134.

Intermediate solutions are also possible, such as for example, having a plurality of metal portions 142 each electrically coupled to a plurality of electric compensating resistors 134.

By virtue of the electric compensating resistors 134, the value of the voltage obtained at the output of the amplifier 128 is lower than the saturation value of the amplifier 128 and the difference in values to be discriminated between that obtained for a pixel 102 in the presence of a ridge of the fingerprint and that obtained for a pixel 102 in the presence of a valley of the fingerprint is more easily measurable. For example, with a value Cf=3 pF, the difference between the values of Vₛ(t₂) for these two types of pixels is 3 mV.

In addition, by virtue of the compensating resistors 134, an increase in the value of V_{P} and V_{CMP} enables the dynamics of the readout circuit 108 to be improved. These compensating resistors 134 also allow a decrease in the value of Cf which enables an increase in the sensitivity of the readout circuit 108, as well as an increase in the integration time t₂−t₁ which improves the amplitude of the signals read.

The value of V_{CMP} may be adjusted by turning on one of the readout circuits 108, without heating the detection elements 106. The adjustment of V_{CMP} is made such that Vₛ=0 at the output of the amplifier 128.

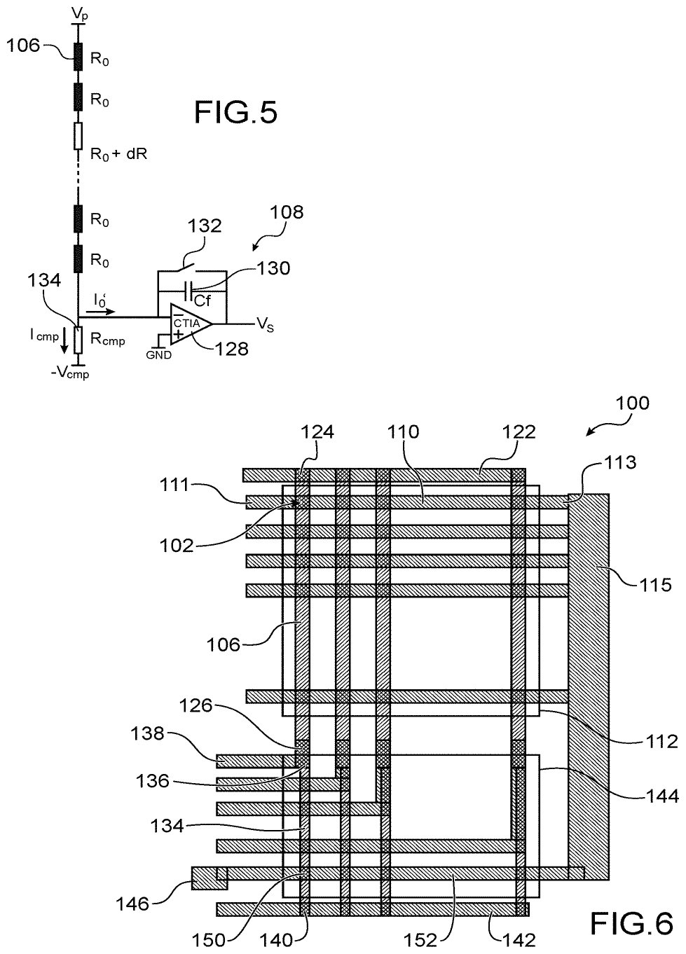

A thermal pattern sensor 100 according to a third embodiment is described below in connection with FIG. 6, which schematically shows a top view of a portion of the sensor 100.

In comparison with the sensor 100 according to the second embodiment, the sensor 100 according to the third embodiment further includes a plurality of electric calibration resistors 150, each electrically coupled to the detection elements 106 of a column of pixels 102 and having a value R₀+dR_{calib}, and which are thermally insulated from the surface 120 intended to be in contact with the element the thermal pattern of which is being measured (by, for example, disposing them away from the matrix of pixels 102, or by covering these electric calibration resistors 150 with a thermally insulating material). In the exemplary embodiment shown in FIG. 6, the electric calibration resistors 150 are formed by the same portions of material as those forming the electric compensating resistors 134 and the detection elements 106.

The electric calibration resistors 150 are to be heated in a similar manner to the detection elements 106. For this, the electric calibration resistors are thermally coupled to a metal portion 152 through which a heating current is to pass. In order to ensure that the current passing through the metal portions 110 is the same as that passing through the metal portion 152 (and thus to have dR_{calib}=dR), one of the ends of the metal portion 152 is coupled to the ground 146 and the other end of the metal portion 152 is coupled to the portion 115, and thus to the metal portions 110. Thus, the heating current sent through one of the metal portions 110 also passes through the portion 115 and the metal portion 152. By selecting a calibration pixel having a thermal capacity equivalent to, for example, the situation of a non-contacting pixel, the voltage Vₛ obtained with a non-contacting measured pixel becomes zero. With a pixel in contact with the skin, only the corresponding signal remains, which enables a better amplification.

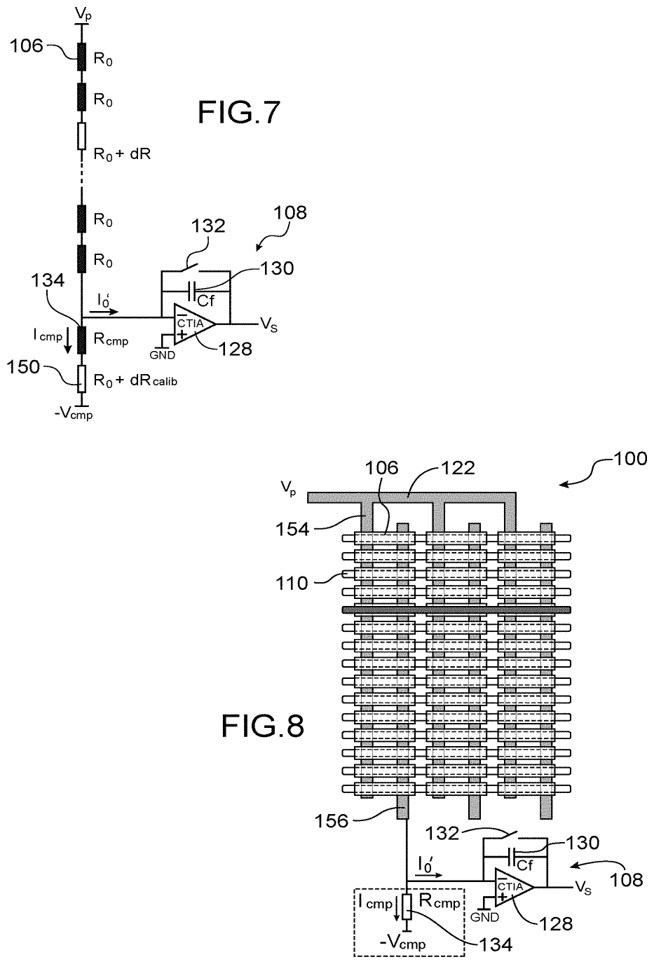

FIG. 7 shows the electrical diagram of a column of pixels 102 of the sensor 100 according to the third embodiment, that is, with an electric compensating resistor 134 and an electric calibration resistor 150 which are electrically coupled in series to the detection elements 106 of each column of pixels 102.

As an alternative to the three previously described embodiments, different configurations are possible, as for example electrically coupling the columns of detection elements 106 to the readout circuits 108 not on a single side of the matrix of pixels 102, but on two opposite sides of the matrix of pixels 102, for example the even columns on one side and the odd columns on the other one.

In the exemplary previously described embodiments, the stack of materials used to form the sensor 100 corresponds to that shown in FIG. 2, with the portions of print-depositable material having a temperature coefficient of resistance greater than about 0.2%/K (that is, detection elements 106 and possibly electric compensating resistors 134 and electric calibration resistors 150) disposed between the metal portions (that is, metal portions 110, 115, 122, and possibly 138, 142, and 152) and the electromagnetic shielding layer 114.

Alternatively, the metal portions may be disposed between the portions of print-depositable material having a temperature coefficient of resistance greater than about 0.2%/K (with these portions disposed against the substrate 104) and the electromagnetic shielding layer 114. According to another alternative, the electromagnetic shielding layer 114 may be disposed between the metal portions and the portions of print-depositable material having a temperature coefficient of resistance greater than about 0.2%/K (with these portions disposed against the substrate 104).

In the previously described embodiments, the detection elements 106 of the pixels 102 belonging to the same column are formed by a single portion of print-depositable material having a temperature coefficient of resistance greater than about 0.2%/K.

A thermal pattern sensor 100 according to a fourth embodiment is described below in connection with FIG. 8, which schematically shows a top view of part of the sensor 100.

In this fourth embodiment, the detection elements 106 of each pixel 102 are formed by portions of print-depositable material having a temperature coefficient of resistance greater than about 0.2%/K that are distinct from each other. In addition, the detection elements 106 of the same column of pixels 102 are electrically coupled in parallel to each other by first and second metal rows 154, 156. The first metal row 154 is electrically coupled to first ends of the detection elements 106 of said column of pixels. The first metal row 154 is configured to apply a bias voltage to the first ends of the detection elements 106. The second metal row 156 is electrically coupled to second ends of the detection elements 106 of said column of pixels. The detection elements 106 of said column of pixels are electrically coupled to the readout circuit 108 through the second metal row 156.

Within the stack of layers forming the sensor 100, the metal rows 154 and 156 may be made at the same level as the metal portions 110, 115, 122 and possibly 138, 142 and 152, and with the same metal material(s).

This fourth embodiment has the advantage of reducing the series electrical resistance formed by the sensor elements 106. On the other hand, the resolution that has to be achieved for making the metal rows 154, 156 is twice that required for making the elements of the sensor 100 according to the previous embodiments.

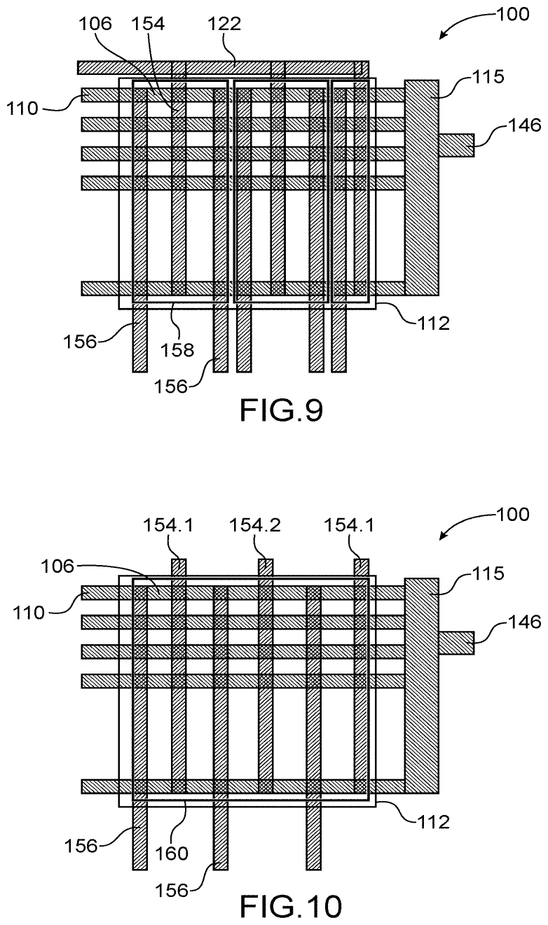

A thermal pattern sensor 100 according to a fifth embodiment is described below in connection with FIG. 9, which schematically shows a top view of part of the sensor 100.

In this fifth embodiment, as in the fourth embodiment, the detection elements 106 of the same column of pixels 102 are electrically coupled in parallel to each other by a first metal row 154 that is electrically coupled to first ends of the detection elements 106 of said column of pixels, and by a second metal row 156 that is electrically coupled to second ends of the detection elements 106 of said column of pixels. The first metal row 154 is further configured to apply a bias voltage to the detection elements, and the second metal row 156 is connected to the readout circuit 108.

The detection elements 106 of the pixels 102 belonging to a plurality of juxtaposed columns (two in the example of FIG. 9) are here formed by a single portion 158 of print-depositable material and having a temperature coefficient of resistance greater than about 0.2%/K.

In the exemplary embodiment shown in FIG. 9, each of the first metal rows 154 supplying the bias voltage to the detection elements 106 is shared by two columns of detection elements 106.

In comparison with the fourth embodiment, the resolution to be achieved for making the metal rows 154, 156 is lower, while maintaining the advantage of reducing the series electrical resistance formed by the detection elements 106.

A thermal pattern sensor 100 according to a sixth embodiment is described below in connection with FIG. 10 which schematically shows a top view of part of the sensor 100.

As in the fourth and fifth embodiments, the detection elements 106 of the same column of pixels 102 are electrically coupled in parallel to each other by the first and second metal rows 154, 156 being used to apply the bias voltage to the detection elements 106 and electrically couple the detection elements 106 to the readout circuit 108.

In contrast, in this sixth embodiment, the detection elements 106 of all the pixels 102 of the sensor 100 are formed by a single portion 160 of print-depositable material having a temperature coefficient of resistance greater than about 0.2%/K. This is possible by virtue of the first metal rows 154 being distributed into two groups: a first group of first metal rows 154.1 and a second group of first metal rows 154.2 alternating with each other (such that a first metal row 154.1 is disposed between two first metal rows 154.2, and a second metal row 154.2 is disposed between two first metal rows 154.1). In addition, reading a row of pixels 102 is performed in two successive steps: a first time by reading the pixels 102 biased by the first metal lines 154.1, and a second time by reading the pixels 102 biased by the first metal lines 154.2.

In this sixth embodiment, each of the second metal lines 156 coupled to the readout circuits 108 is shared by two juxtaposed columns of pixels 102. Each readout circuit 108 is thus shared by two juxtaposed columns of pixels 102.

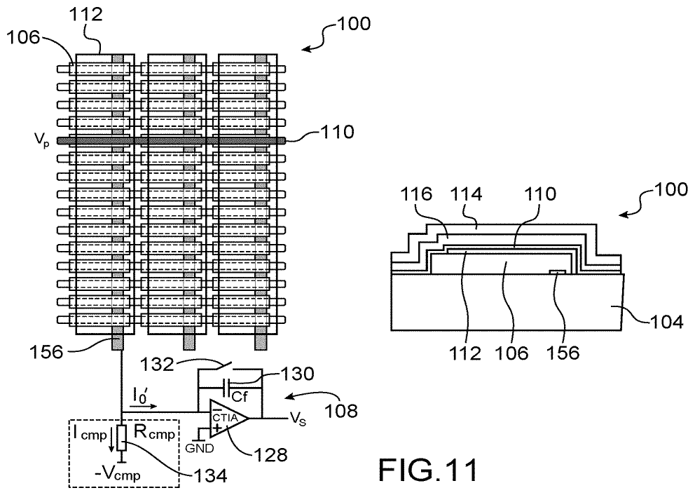

A thermal pattern sensor 100 according to a seventh embodiment is described below in connection with FIG. 11, which schematically shows a top view of part of the sensor 100 and a cross-section view of a pixel of the sensor 100 according to this seventh embodiment.

In contrast to the previous embodiments, heating the detection elements 106 is not obtained by Joule effect by virtue of the heat generated by the metal of the metal rows 110, but directly by the heat generated within the detection elements 106 by virtue of the current fed into the detection elements 106 by the metal rows 110. As is visible in FIG. 11, the dielectric portions 112 are not formed by a continuous dielectric material layer so that at each pixel 102, the metal portion 110 has a part that is in contact with the portion of material forming the detection element 106 of the pixel 102.

In this seventh embodiment, each of the second metal rows 156 couples the detection elements 106 of a column of pixels to a readout circuit 108. The sensor 100 does not include the first metal rows 154.

Upon reading a row of pixels 102, a bias voltage V_{P} is applied to the metal portion 110 of the row of pixels 102 to be read, and advantageously, the reference potential applied to the amplifiers 128 of the readout circuits 108 is applied to the metal portions 110 of the other rows of pixels 102 not read.

As an alternative to this seventh embodiment, it is possible that at least part of the pixels 102 of the same column includes detection elements 106 formed by a common portion of material.

For all the previously described embodiments, the different material layers forming the sensor 100, and especially the material layer forming the detection elements 106, are print deposited. Different printing techniques may be used, such as for example:
screen printing: the material, in liquid or paste form, is deposited onto a mask previously disposed on the surface on which the material is to be deposited, and is then scraped so that the material passes through openings formed in the mask and which define the portions of material to be deposited,
gravure printing or rotogravure: a cylinder is etched, for example with a photosensitive technique, according to the pattern of the material to be deposited. The material, in liquid or paste form, is deposited in the holes etched in the cylinder, and then the cylinder is rolled onto the surface on which the material is to be deposited,
Letterpress: a technique similar to gravure printing, with the difference that the pattern of the material to be deposited is not etched in the cylinder, but is formed in relief on the cylinder,
offset: a first cylinder deposits the material, in liquid or paste form, on a second cylinder which then passes on the surface on which the material is deposited,
slot die coating: the material, in liquid or paste form, is pushed between two lips of deposition equipment with a spacing between the lips, that is controlled and depends on the desired throughput. The deposition equipment or the surface on which the deposition is performed is moved during deposition to form the desired rows of material.

Although not shown, and for all the previously described embodiments, the sensor 100 may further include an electronic processing circuit capable of constructing an overall image of the thermal pattern from the signals obtained at the output of the readout circuits 108. This electronic processing circuit may also be capable of comparing this image to a plurality of images stored in a database in order to identify whether the detected thermal pattern corresponds to any of those stored in the database. The electronic processing circuit may also be capable of displaying an image of the detected thermal pattern.

In all the previously described embodiments, the material used to form the detection elements 106 corresponds to PEDOT:PSS. Alternatively, other materials may be used for making the detection elements 106. For example, it is possible to use Cytochrome c type proteins for making these elements. Details of the use of such proteins, and which may be applied for making the sensor 100 according to any of the preceding embodiments, are given in document “Uncooled Long-Wavelength Infrared Sensors Using Cytochrome C Protein on Suspension Electrodes With CMOS Readout Circuits”, by P-H Yen et al, IEEE Sensors Journal, vol. 19, Issue 22, 15 Jul. 2019, pp. 10221-10227. According to another example, it is possible to use graphene for making these elements. Details of such graphene are, for example, given in documents “Reduced Graphene Oxide as an Excellent Temperature Sensor” by Khurana G et al, Journal of Nanoscience and Nanotechnology Applications, Volume 2, Issue 1, and “A Flexible Temperature Sensor Based on Reduced Graphene Oxide for Robot Skin Used in Internet of Things”, Sensors (Basel). 2018 Can; 18(5): 1400.

1. A sensor of a thermal pattern of an element intended to be in contact with the sensor, measuring thermos-resistive properties of a detection material, including a matrix of multiple rows and columns of pixels, each pixel comprising at least:
a detection element formed by a portion of the detection material which comprises at least one of: PEDOT:PSS, graphene, Cytochrome c type proteins, and having a temperature coefficient of resistance greater than about 0.2%/K;
a metal portion configured to heat the detection element of the pixel;
a first portion of dielectric material disposed between the detection element and the metal portion, configured to provide electrical insulation of at least part of the detection element from the metal portion;
and wherein:
the detection elements of a same column of pixels all have substantially a same electrical resistance value and are electrically coupled to each other and to a readout circuit configured to read an electric current for passing through said detection elements;
the metal portions of a same row of pixels are electrically coupled to each other;
the sensor further includes an electromagnetic shielding layer covering all the detection elements of the matrix and electrically insulated from said detection elements.

2. The sensor according to claim 1, wherein the detection material is PEDOT:PSS, and/or wherein the electromagnetic shielding layer includes PEDOT:PSS.

3. The sensor according to claim 2, wherein the PEDOT:PSS of the detection elements and/or of the electromagnetic shielding layer includes a PSS to PEDOT weight ratio between about 2.5 and 10.

4. The sensor according to claim 2, wherein the electromagnetic shielding layer includes a material identical to that of the detection elements.

5. The sensor according to claim 1, further including a circuit configured to apply, to the metal portions, a heating voltage dissipating in each pixel a power between about 0.01 mW and 10 mW.

6. The sensor according to claim 1, wherein the detection elements have an electrical conductivity between about 0.3 S·m⁻¹ and 20,000 S·m⁻¹.

7. The sensor according to claim 1, comprising several readout circuits each electrically coupled to at least one of the columns of pixels, and wherein each readout circuit includes at least:
a capacitive transimpedance amplifier, an input of which is electrically coupled to the detection elements of said at least one of the columns of pixels, and
a feedback capacitor comprising a first electrode electrically coupled to said input of the capacitive transimpedance amplifier and a second electrode electrically coupled to an output of the capacitive transimpedance amplifier, and
a switch electrically coupled in parallel to the feedback capacitor.

8. The sensor according to claim 1, further including a plurality of electric compensating resistors each electrically coupled to the detection elements of a column of pixels and having a value equal to the sum of the electrical resistances of the detection elements of said column of pixels.

9. The sensor according to claim 8, wherein the electric compensating resistors include at least one portion of the detection material having a similar composition to that of the detection elements of the pixels.

10. The sensor according to claim 1, further including a plurality of electric calibration resistors each electrically coupled to the detection elements of a column of pixels.

11. The sensor according to claim 10, wherein the electric calibration resistors are formed by at least one portion of the detection material having a similar composition to that of the detection elements of the pixels, thermally coupled to a metal row which includes a first end connected to the ground and a second end electrically coupled to the metal portions of the pixels.

12. The sensor according to claim 1, wherein:
the detection elements of each pixel are formed by portions of the detection material that are distinct from each other, or
the detection elements of the pixels belonging to a same column are formed by a single portion of the detection material, or
the detection elements of the pixels belonging to several juxtaposed columns are formed by a single portion of the detection material, or
the detection elements of all the pixels of the sensor are formed by a single portion of the detection material.

13. The sensor according to claim 1, wherein the detection elements of a same column of pixels are electrically coupled in parallel to each other by a first metal row electrically coupled to first ends of the detection elements of said column of pixels and to which a bias voltage is to be applied, and by a second metal row electrically coupled to second ends of the detection elements of said column of pixels and through which the detection elements of said column of pixels are electrically coupled to the readout circuit.

14. The sensor according to claim 13, wherein at least one first metal row is common to two juxtaposed columns of pixels and/or at least one second metal row is common to two juxtaposed columns of pixels.

15. The sensor according to claim 1, further including an electric bias metal row electrically coupled to the detection elements of the pixels, and wherein, in each pixel, the first portion of dielectric material electrically insulates the entire detection element from the metal portion.
